(19) United States
(12) Patent Application Publication
(10) Pub. No.: US 2026/0219391 A1
(43) Pub. Date: Jul. 30, 2026

(54) LIDAR VELOCITY MEASUREMENTS

(71) Applicant: Cepton Technologies, Inc., San Jose, CA (US)

(72) Inventors: Si Tan, Santa Clara, CA (US); Liqun Han, Pleasanton, CA (US); Chang Seok Shin, Oakland, CA (US); Jun Pei, Saratoga, CA (US); Mark A. McCord, Los Gatos, CA (US); Chusheng Qiu, San Jose, CA (US)

(73) Assignee: Cepton Technologies, Inc., San Jose, CA (US)

(21) Appl. No.: 19/631,153

(22) Filed: Mar. 27, 2026

Related U.S. Application Data
(63) Continuation-in-part of application No. 19/436,809, filed on Dec. 30, 2025.
(60) Provisional application No. 63/739,911, filed on Dec. 30, 2024.

(51) Int. Cl. G01S 17/58; G01S 7/481; G01S 7/4865; G01S 7/487; G01S 17/89

(52) U.S. Cl. CPC G01S 17/58; G01S 7/4815; G01S 7/4817; G01S 7/4865; G01S 7/4873; G01S 7/4876; G01S 17/89

(57) ABSTRACT

Distinct lines of illumination produced by first and second lasers are swept across a field of view using a scanning mirror, illuminating the field of view with a known time delay. The second laser may be physically offset by a fractional pixel distance relative to the first laser. Reflections from the field of view are detected by corresponding detectors, and a processing unit can interleave pixels generated from the distinct illuminations to create a higher-resolution combined point cloud. A pixel-by-pixel radial velocity can be calculated based on a change in radial distance between corresponding pixels over the known time delay. Edge artifacts, such as anomalies caused by laterally moving objects, are detected and filtered by comparing the pixel-level radial velocities to a predefined threshold limit. The remaining valid pixels can then be grouped into recognized objects to calculate a velocity of the object.

### CROSS-REFERENCES TO RELATED APPLICATIONS

This application is a continuation-in-part of U.S. patent application Ser. No. 19/436,809, filed on Dec. 30, 2025, which claims the benefit of U.S. Provisional Patent Application No. 63/739,911, filed on Dec. 30, 2024, each of which is incorporated by reference in its entirety for all purposes.

### BACKGROUND

Three-dimensional sensors are components in a variety of rapidly growing fields, including autonomous vehicles, drones, robotics, and security applications. lidar systems, in particular, are capable of generating detailed three-dimensional maps of an environment, or portion thereof, by projecting an optical beam and detecting the light reflected from objects. A time-of-flight (ToF) calculation, based on the time difference between the emission of the optical beam and the detection of its reflection, allows the system to determine the distance to various points on an object, thereby creating a “point cloud” that represents the 3D environment.

Scanning lidar systems can achieve high angular resolution at a relatively affordable cost, making them suitable for mass-market applications. Examples of scanning lidar systems are provided in U.S. Pat. No. 10,690,754, granted on Jun. 23, 2020, and U.S. patent application Ser. No. 18/531,507, filed on Dec. 6, 2023, which are incorporated by reference for all purposes. However, improved scanning systems, apparatuses, and/or methods are desired.

### SUMMARY

In certain configurations, a system for detecting velocity of an object using lidar comprises a first laser configured to produce a first line of illumination in a field of view; a second laser configured to produce a second line of illumination in the field of view, wherein the second line of illumination is angularly separated from the first line of illumination by a known angle, and the known angle is between 1 and 15 degrees; a scanning mirror configured to sweep the first and second lines of illumination across the field of view, wherein an object in the field of view is illuminated by the second line of illumination at a known time delay after being illuminated by the first line of illumination; the known time delay is a function of the known angle and an angular velocity of the scanning mirror; a first detector configured to detect a first reflection of the first laser from the object; a second detector configured to detect a second reflection from the second laser from the object; and/or a processing unit configured to generate a first sub image of the object based on data detected from reflections from the first laser, including detecting the first reflection, wherein the first sub image is a first point cloud, generate a second sub image of the object based on data detected from reflections from the second laser, including detecting the second reflection, wherein the second sub image is a second point cloud, and/or calculate a three-dimensional velocity vector of the object by analyzing a change in position of the object between the first sub image and the second sub image and the known time delay. In some cases, the first laser is part of a first laser array and the second laser is part of a second laser array; the first laser array and the second laser array share a focusing lens; the first laser array, the second laser array, the first detector, the second detector, and the processing unit are on the same chip; and/or the scanning mirror is an oscillating mirror or a rotating polygonal mirror.

In certain configurations, a system for detecting velocity of an object using lidar comprises a first laser configured to produce a first line of illumination in a field of view; a second laser configured to produce a second line of illumination in the field of view, wherein the second line of illumination is angularly separated from the first line of illumination by a known angle; a scanning mirror configured to sweep the first and second lines of illumination across the field of view, wherein an object in the field of view is illuminated by the second line of illumination at a known time delay after being illuminated by the first line of illumination; the known time delay is based on the known angle; a first detector configured to detect a first reflection of the first laser from the object; a second detector configured to detect a second reflection from the second laser from the object; and/or a processing unit configured to calculate a first position of the object based on detecting the first reflection, calculate a second position of the object based on detecting the second reflection, and/or calculate a velocity of the object based on a difference between the first position, the second position, and the known time delay. In some configurations, the known angle is between 1 and 15 degrees; the known time delay is a function of the known angle and an angular velocity of the scanning mirror; the processing unit is further configured to calculate a three-dimensional velocity vector of the object by analyzing a change in position of the object between a first sub image generated from data with the first reflection and a second sub image generated from data with the second reflection; the first laser is part of a first laser array and the second laser is part of a second laser array; the first laser array and the second laser array share a focusing lens; the first laser array, the second laser array, the first detector, the second detector, and the processing unit are on the same chip; the scanning mirror is an oscillating mirror or a rotating polygonal mirror.

In certain embodiments, a method for detecting velocity of an object using lidar comprises emitting light from a first laser configured to produce a first line of illumination; emitting light from a second laser configured to produce a second line of illumination; wherein the second line of illumination is angularly separated from the first line of illumination by a known angle; sweeping, using a scanning mirror, the first line of illumination and the second line of illumination across a field of view, wherein an object in the field of view is illuminated by the second line of illumination at a known time delay after being illuminated by the first line of illumination; detecting, using at least one detector array, reflections of the first and second lines of illumination from the object, and calculating a first position of the object based on the reflection of the first line of illumination; calculating a second position of the object based on the reflection of the second line of illumination; and/or calculating a velocity of the object based on a difference between the first position, the second position, and the known time delay. In some configurations, the known angle is between 1 and 15 degrees; the known time delay is a function of the known angle and an angular velocity of the scanning mirror; the method further comprises calculating a three-dimensional velocity vector of the object by analyzing a change in position of the object between a first sub image generated from data with the first reflection and a second sub image generated from data with the second reflection; the first laser is part of a first laser array and the second laser is part of a second laser array; the first laser array and the second laser array share a focusing lens; the first laser array, the second laser array, the first detector, the second detector, and the processing unit are on the same chip; and/or the scanning mirror is an oscillating mirror or a rotating polygonal mirror.

In some configurations, a system for lidar comprises a first laser source configured to emit light at a first wavelength; a second laser source configured to emit light at a second wavelength, different from the first wavelength; a scanning mirror configured to scan light from the first laser source across a first field of view, scan light from the second laser sources across a second field of view, and receive reflected light from the first field of view and the second field of view; a beam splitter positioned to receive the reflected light from the scanning mirror, the beam splitter configured to separate the reflected light into a first optical path corresponding to the first wavelength and a second optical path corresponding to the second wavelength; a first detector positioned in the first optical path to detect reflected light of the first wavelength; and/or a second detector positioned in the second optical path to detect reflected light of the second wavelength. In some configurations, the system further comprises a first lens with a first focal length in the first optical path; and/or a second lens with a second focal length in the second optical path, wherein the second focal length is longer than the first focal length. In certain configurations, the first optical path is optimized for a first detection range; a first field of view, and the second optical path is optimized for a second detection range and a second field of view, wherein the second detection range is longer than the first detection range, and the second field of view is narrower than the first field of view; the first wavelength and the second wavelength are between 850 nm 960 nm; the first wavelength is 905 nm, plus or minus 10 nm, and the second wavelength is 940 nm, plus or minus 10 nm; and/or the system further comprises a processing unit configured to generate a three-dimensional point cloud by combining data from at least the first detector and the second detector.

In certain configurations, a method for lidar to detect near and far objects comprises emitting a first laser pulse within a first field of view, wherein the first laser pulse is characterized by a first wavelength; emitting a second laser pulse within a second field of view, wherein the second laser pulse is characterized by a second peak wavelength; receiving reflected light from the first field of view and the second field of view; separating the reflected light into a first optical path corresponding to the first wavelength and a second optical path corresponding to the second wavelength; detecting, using a first detector positioned in the first optical path, reflected light of the first wavelength; detecting, using a second detector positioned in the second optical path, reflected light of the second wavelength; calculating a first distance to a first object in the first field of view based on the first detector detecting reflected light corresponding to the first wavelength; and/or calculating a second distance to a second object in the second field of view based on the second detector detecting reflected light corresponding to the second wavelength. In certain configurations, the method further comprises passing light of the first wavelength though a first lens with a first focal length, wherein the first lens is in the first optical path, and passing light of the second wavelength through a second lens with a second focal length, wherein the second lens in in the second optical path.

In certain configurations, a method for measuring distances using a lidar system comprises emitting a first laser pulse toward a field of view; emitting a second laser pulse toward a second field of view; in response to detecting a reflection from the laser pulse from a first detector, initiating a first time-of-flight measurement to calculate a first distance to a first object in the first field of view; waiting for a predetermined time delay after the emission of the second laser pulse before detecting a reflection from the second laser pulse; initiating a second time-of-flight measurement based on the reflection from the second laser pulse; and/or calculating a second distance to a second object in the second field of view based on the second time-of-flight measurement, wherein the second range is more distant from the LIDAR system than the first range. In some configurations, the predetermined time delay corresponds to the round-trip travel time of light to a minimum distance of the second field of view; the minimum distance of the second range is equal to or greater than 250 meters; and/or the first field of view and the second field of view are at least partially overlapping.

Further areas of applicability of the present disclosure will become apparent from the detailed description provided hereinafter. It should be understood that the detailed description and specific examples, while indicating various embodiments, are intended for purposes of illustration only and are not intended to limit the scope of the disclosure.

### BRIEF DESCRIPTION OF THE DRAWINGS

The present disclosure is described in conjunction with the appended figures.

FIG. 1 illustrates an embodiment of a lidar sensor for three-dimensional imaging.

FIG. 2 illustrates an embodiment of a lidar system using two different wavelengths to simultaneously measure shorter and longer distances.

FIG. 3 is an example graphical representation of two fields of view for the dual-wavelength lidar system of FIG. 2.

FIG. 4 is a schematic diagram of an embodiment of a lidar system configured for rapid velocity measurement, utilizing two angularly separated laser arrays.

FIG. 5 is a graph illustrating the relationship between the angular separation of laser arrays, distance measurement precision, and the minimum resolvable velocity for the example lidar system shown in FIG. 4.

FIG. 6 illustrates a flowchart of an embodiment of a process for lidar to detect near and far objects.

FIG. 7 illustrates a flowchart of an embodiment of a process for measuring far distances using a lidar system.

FIG. 8 illustrates a flowchart of an embodiment of a process for detecting velocity of an object using lidar.

FIG. 9 illustrates various embodiments of fractional pixel shifting between a first column of pixels and a second column of pixels.

FIG. 10 illustrates an embodiment of a point cloud generated by scanning a first laser array and a second laser array across a field of view, where the second laser is horizontally offset from the first laser.

FIG. 11 illustrates an embodiment of a series of pulses from a first laser array and a second laser array scanned across a field of view, wherein pixels from the second laser array are vertically offset relative to pixels from the first laser array.

FIG. 12 illustrates an embodiment of a lidar point cloud where pixels from a second laser are shifted both horizontally and vertically relative to pixels from a first laser to achieve multi-axis spatial interleaving.

FIG. 13 illustrates an embodiment of an optical arrangement for a lidar system where a first laser and a second laser share a common housing and have separate optical paths that create an overlap region for radial velocity computation.

FIG. 14 illustrates an embodiment of an optical arrangement for a lidar system where a first laser and a second laser are part of physically separate, independent lidar units that are calibrated and synchronized to create an overlap region for velocity measurements.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides exemplary embodiment(s), and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

Additional examples of lidar systems are provided in commonly owned U.S. patent application Ser. No. 18/787,427, filed on Jul. 29, 2024 and U.S. patent application Ser. No. 19/027,522, filed on Jan. 17, 2025, which are incorporated by reference for all purposes.

This disclosure relates generally to scanning lidar systems. By way of example, some embodiments relate to using two different wavelengths for short range sensing and long range sensing, using a time delay to measure longer distances, and/or using two lasers a few degrees apart to extract velocity measurements.

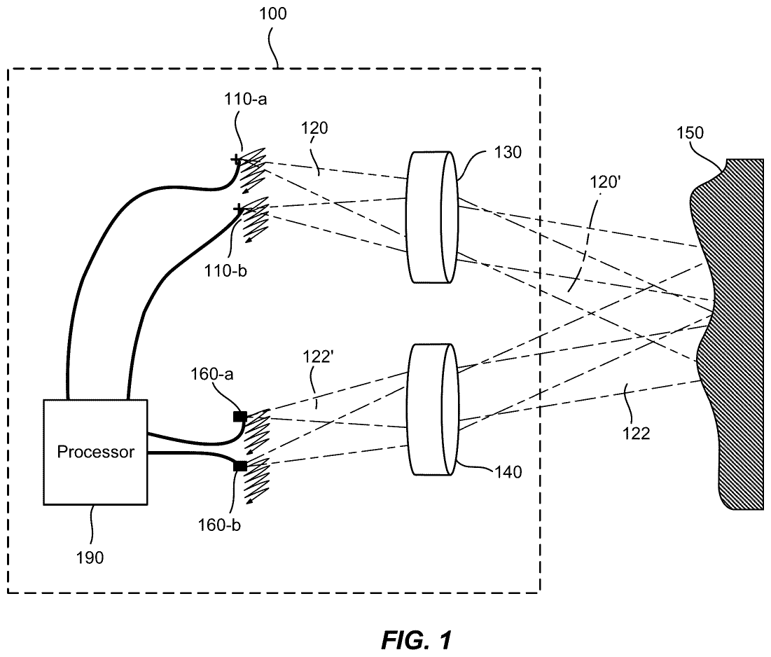

FIG. 1 illustrates an embodiment of a lidar sensor 100 for three-dimensional imaging. The lidar sensor 100 includes an emission lens 130 and a receiving lens 140. The lidar sensor 100 includes a light source 110-a disposed substantially in a back focal plane of the emission lens 130. The light source 110-a is operative to emit a light pulse 120 from a respective emission location in the back focal plane of the emission lens 130. The emission lens 130 is configured to collimate and direct the light pulse 120 toward an object 150 located in front of the lidar sensor 100. For a given emission location of the light source 110-a, the collimated light pulse 120′ is directed at a corresponding angle toward the object 150.

A portion 122 of the collimated light pulse 120′ is reflected off of the object 150 toward the receiving lens 140. The receiving lens 140 is configured to focus the portion 122′ of the light pulse reflected off of the object 150 onto a corresponding detection location in the focal plane of the receiving lens 140. The lidar sensor 100 further includes a detector 160-a disposed substantially at the focal plane of the receiving lens 140. The detector 160-a is configured to receive and detect the portion 122′ of the light pulse 120 reflected off of the object at the corresponding detection location. The corresponding detection location of the detector 160-a is optically conjugate with the respective emission location of the light source 110-a.

The light pulse 120 may be of a short duration, for example, 10 ns pulse width. The lidar sensor 100 further includes a processor 190 coupled to the light source 110-a and the detector 160-a. The processor 190 is configured to determine a time of flight (TOF) of the light pulse 120 from emission to detection. Since the light pulse 120 travels at the speed of light, a distance between the lidar sensor 100 and the object 150 may be determined based on the determined time of flight.

One way of scanning a laser beam (e.g., light pulse 120′) across a FOV is to move the light source 110-a laterally relative to the emission lens 130 in the back focal plane of the emission lens 130. For example, the light source 110-a may be raster scanned to a plurality of emission locations in the back focal plane of the emission lens 130 as illustrated in FIG. 1. The light source 110-a may emit a plurality of light pulses at the plurality of emission locations. Each light pulse emitted at a respective emission location is collimated by the emission lens 130 and directed at a respective angle toward the object 150, and impinges at a corresponding point on the surface of the object 150. Thus, as the light source 110-a is raster scanned within a certain area in the back focal plane of the emission lens 130, a corresponding object area on the object 150 is scanned. The detector 160-a may be raster scanned to be positioned at a plurality of corresponding detection locations in the focal plane of the receiving lens 140, as illustrated in FIG. 1. The scanning of the detector 160-a is typically performed synchronously with the scanning of the light source 110-a, so that the detector 160-a and the light source 110-a are always optically conjugate with each other at any given time.

By determining the time of flight for each light pulse emitted at a respective emission location, the distance from the lidar sensor 100 to each corresponding point on the surface of the object 150 may be determined. In some embodiments, the processor 190 is coupled with a position encoder that detects the position of the light source 110-a at each emission location. Based on the emission location, the angle of the collimated light pulse 120′ may be determined. The X-Y coordinate of the corresponding point on the surface of the object 150 may be determined based on the angle and the distance to the lidar sensor 100. Thus, a three-dimensional image of the object 150 may be constructed based on the measured distances from the lidar sensor 100 to various points on the surface of the object 150. In some embodiments, the three-dimensional image may be represented as a point cloud, i.e., a set of X, Y, and Z coordinates of the points on the surface of the object 150.

In some embodiments, the intensity of the return light pulse 122′ is measured and used to adjust the power of subsequent light pulses from the same emission point, in order to prevent saturation of the detector, improve eye-safety, or reduce overall power consumption. The power of the light pulse may be varied by varying the duration of the light pulse, the voltage or current applied to the laser, or the charge stored in a capacitor used to power the laser. In the latter case, the charge stored in the capacitor may be varied by varying the charging time, charging voltage, or charging current to the capacitor. In some embodiments, the reflectivity, as determined by the intensity of the detected pulse, may also be used to add another dimension to the image. For example, the image may contain X, Y, and Z coordinates, as well as reflectivity (or brightness).

The angular field of view (AFOV) of the lidar sensor 100 may be estimated based on the scanning range of the light source 110-a and the focal length of the emission lens 130 as,

$$A F O V = 2 {tan}^{- 1} ( \frac{h}{2 f} ) ,$$

where h is scan range of the light source 110-a along certain direction, and f is the focal length of the emission lens 130. For a given scan range h, shorter focal lengths would produce wider AFOVs. For a given focal length f, larger scan ranges would produce wider AFOVs. In some embodiments, the lidar sensor 100 may include multiple light sources disposed as an array at the back focal plane of the emission lens 130, so that a larger total AFOV may be achieved while keeping the scan range of each individual light source relatively small. Accordingly, the lidar sensor 100 may include multiple detectors disposed as an array at the focal plane of the receiving lens 140, each detector being conjugate with a respective light source. For example, the lidar sensor 100 may include a second light source 110-b and a second detector 160-b, as illustrated in FIG. 1. In other embodiments, the lidar sensor 100 may include four light sources and four detectors, or eight light sources and eight detectors. In one embodiment, the lidar sensor 100 may include eight light sources arranged as a 4×2 array and eight detectors arranged as a 4×2 array, so that the lidar sensor 100 may have a wider AFOV in the horizontal direction than its AFOV in the vertical direction. According to various embodiments, the total AFOV of the lidar sensor 100 may range from about 5 degrees to about 15 degrees, or from about 15 degrees to about 45 degrees, or from about 45 degrees to about 120 degrees, depending on the focal length of the emission lens, the scan range of each light source, and the number of light sources.

The light source 110-a may be configured to emit light pulses in the near infrared wavelength ranges. The energy of each light pulse may be in the order of microjoules, which can be considered to be eye-safe for repetition rates in the kHz range. For light sources operating in wavelengths greater than about 1500 nm (in the near infrared wavelength range), the energy levels could be higher as the eye does not focus at those wavelengths. The detector 160-a may comprise a silicon avalanche photodiode, a photomultiplier, a PIN diode, or other semiconductor sensors.

Additional lidar sensors are described in commonly owned U.S. patent application Ser. No. 15/267,558 filed Sep. 15, 2016, Ser. No. 15/971,548 filed on May 4, 2018, Ser. No. 16/504,989 filed on Jul. 8, 2019, Ser. No. 16/775,166 filed on Jan. 28, 2020, Ser. No. 17/032,526 filed on Sep. 25, 2020, Ser. No. 17/133,355 filed on Dec. 23, 2020, Ser. No. 17/205,792 filed on Mar. 18, 2021, and Ser. No. 17/380,872 filed on Jul. 20, 2021, the disclosures of which are incorporated by reference for all purposes.

In some lidar systems, light from an array of lasers is scanned horizontally across the field of view (FOV) by an oscillating mirror. In some configurations, light is projected from array of lasers by a transmit lens system (e.g., comprising one or more lenses). Light reflected off objects in the FOV is received by the oscillating mirror and imaged onto a detector array. In some configurations, a receive lens system (e.g., comprising one or more lenses) is used to image light from the oscillating mirror onto the detector array. The laser array may be a VCSEL array or a single laser with a non-cylindrical optic to form a line image. A detector array may be a single monolithic array of silicon single photon detectors (SPADs) and/or other types of photodetectors such as avalanche photodetectors (APDs). The laser and detector arrays are arranged to cover the vertical FOV so that by scanning the arrays horizontally, the full FOV may be covered. In some implementations, a rotating polygonal mirror may be used in place of an oscillating mirror.

A signal from a detector in the detector array is analyzed by a processing unit, and a time of flight (ToF) time difference between a laser pulse and the received light is used to ascertain (e.g., calculate) a distance to an object within the FOV. Multiple signals from the detector are used to construct a 3D image of the FOV (e.g., generating a three-dimensional point cloud).

In some situations, it can be difficult to cover both near objects and distant objects with adequate spatial and temporal (e.g., distance) resolution. Also, some ToF designs do not provide instantaneous (or near instantaneous) information about the velocity of an object.

### A. Dual-Wavelength Architecture for Multi-Range Sensing

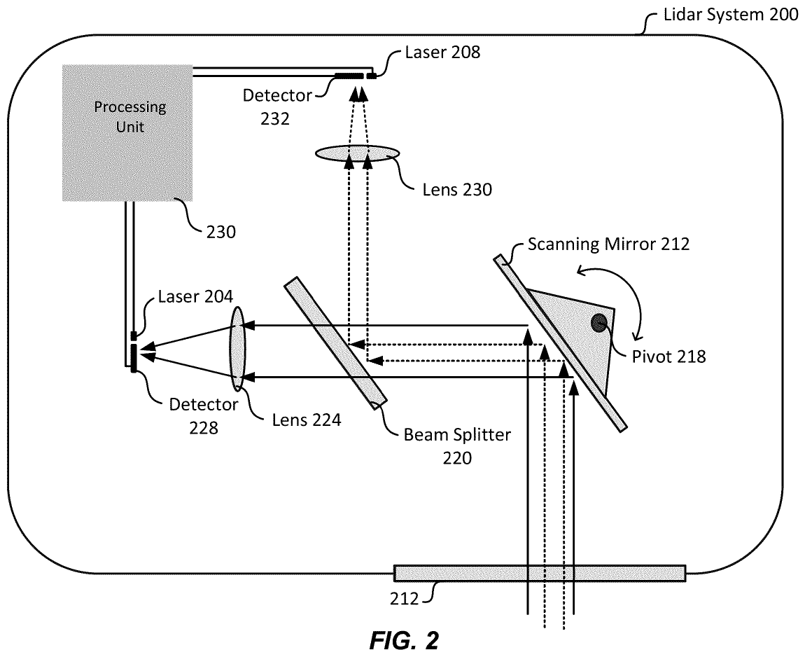

FIG. 2 depicts an embodiment of a lidar system 200 using two different wavelengths to simultaneously measure shorter distances with a wider field of view and longer distances with a narrower field of view.

It can be challenging to design a single optical system that provides adequate spatial and distance resolution for both near-field and far-field objects simultaneously. An optical configuration optimized for long-range detection may have a narrow FOV and poor resolution at close distances, while a wide-FOV system for near-field sensing may lack the power and resolution to detect distant objects effectively. FIG. 2 shows an embodiment that overcomes one or more of these difficulties. Two sets of lasers with different wavelengths are used, with a first set optimized for near range and/or wide FOV, and the second set optimized for long range and/or narrower FOV. For example, the second set of lasers may have higher power, or be focused into a narrow line. For clarity, the lasers and/or transmit optics are not shown in FIG. 2. For a detection path, a beam splitter is used to direct the first wavelength to one set of detectors, and the second wavelength to a second set of detectors. The imaging lens for the second set of detectors may have a longer focal length in order to improve resolution and/or light collection from the longer distance, at perhaps the expense of a reduced FOV.

In the example shown, the lidar system 200 uses a first laser 204. The first laser 204 operates at a first wavelength (e.g., a peak wavelength of 905 nm, ±5 nm). In some configurations, the first laser 204 is part a first laser array (e.g., the laser array extents into and/or out of the sheet and/or has additional columns). Each laser in the first laser array is configured to operate at the first wavelength. The first laser 204 (and first laser array, if used) is optimized for wide-FOV, short-range detection.

The lidar system 200 comprises a second laser 208. The second laser 208 operates at a second wavelength (e.g., 940 nm, ±5 nanometers). Some configurations, the second laser 208 is part of a second laser array (e.g., the laser array extends into and/or out of the sheet and/or has additional columns). Each laser on the second laser array is configured to operate the second wavelength. The second laser 208 (and second laser array, if used) is optimized for narrow-FOV, long-range detection.

Light from the first laser 204 and light from the second laser 208 is transmitted to a scanning mirror 212 and through and IR window 216 into one or more fields of view of an environment. Scanning mirror 212 can be configured to oscillate back and forth (e.g., about a pivot 218), or the scanning mirror 212 can rotate in a circle (e.g., as part of a polygonal mirror). The example shown in FIG. 2 depicts an oscillating scanning mirror.

Light from the first laser 204 passes through a beam splitter 220 before being incident on the scanning mirror 212. The second laser 208 is reflected by the beam splitter 220 before being incident on the scanning mirror 212. The beam splitter 220 can be a “hot” mirror or a “cold” mirror. A hot mirror reflects wavelengths of light longer than a cut off wavelength, and a cold mirror reflects wavelengths of light shorter than a cutoff wavelength. In the example shown in FIG. 2, the beam splitter 220 is a hot mirror reflecting longer wavelengths of light and passing shorter wavelengths of light. For example, the hot mirror acting as the beam splitter 220 has a cut off wavelength of around 920 nanometers, such that wavelengths higher than 920 nanometers are reflected and wavelengths shorter than 920 nanometers are transmitted.

Reflected light from the environment is collected by the scanning mirror 212 and directed towards the beam splitter 220. The beam splitter 220 is configured to transmit light of the first wavelength (e.g., 905 nm) and reflect light of the second wavelength (e.g., 940 nm), or vice-versa.

The light of the first wavelength is directed along a first optical path. A first lens 224 is arranged on the first optical path. The first optical path extends from the beam splitter 220 to a first detector 228. Light passing through the first lens 224 is imaged onto the first detector 228. The first detector 228 can be part of a first detector array. For example, the first detector array comprises one or more columns of detectors extending into and/or out of the sheet.

The light of the second wavelength is directed along a second optical path. A second lens 230 is arranged on the second optical path. The second optical path extends from the beam splitter 220 to a second detector 232. Light passing through the second lens 230 is imaged onto the second detector 232. The second detector 232 can be part of a second detector array. For example, the second detector array comprises one or more columns of detectors extending into and/or out of the sheet.

The first optical path is optimized for short-range sensing, providing a wide field of view. The second optical path is optimized for long-range sensing, providing a narrower field of view than the first optical path. The first lens 224 has a shorter focal length than the second lens 230. The longer focal length of the second lens 230 provides higher magnification, which improves angular resolution and light collection efficiency for distant objects.

The first lens 224 and the second lens 230 can be simple lenses or optical trains (e.g., optical assemblies with an arrangement of optical components such as one or more lenses, mirrors, prisms, aperture stops, etc.).

The first lens 224 (and by analogy the second lens) can be used to focus light onto just one detector, just one column of the first detector array, or multiple columns of the first detector array. In some configurations, light from the first laser 204 also transmits through the first lens 224, though in other configurations, light from the first laser 204 passes through a lens separate from the first lens 224. In some configurations, light from the second laser 208 also transmits through the second lens 230, though in other configurations, light from the second laser 208 passes through a lens separate from the second lens 230.

While 905 nm and 940 nm wavelengths are provided as examples, other wavelengths (e.g., that can be separated optically) can be used. For example, light within the range of 850 nm and 960 nm is used. Light with a wavelength of 850 nm is borderline visible. Light of the first wavelength and light of the second wavelength are each characterized by a peak wavelength (e.g., the peak wavelength of the first light is 905 nm and the peak wavelength of the second light is 940 nm). In some configurations, the first wavelength is separated from the second wavelength by at least 10, 20, or 30 nm and by no more than 30, 50, or 60 nm).

A processing unit 240 is configured to calculate a time of flight for light to be emitted from a laser, reflect from an object in a field of view, and return to a detector. In some configurations, a detector (and array) and a laser (and array), and/or processing unit are integrated onto one chip. In some configurations, each detector array has its own processing unit.

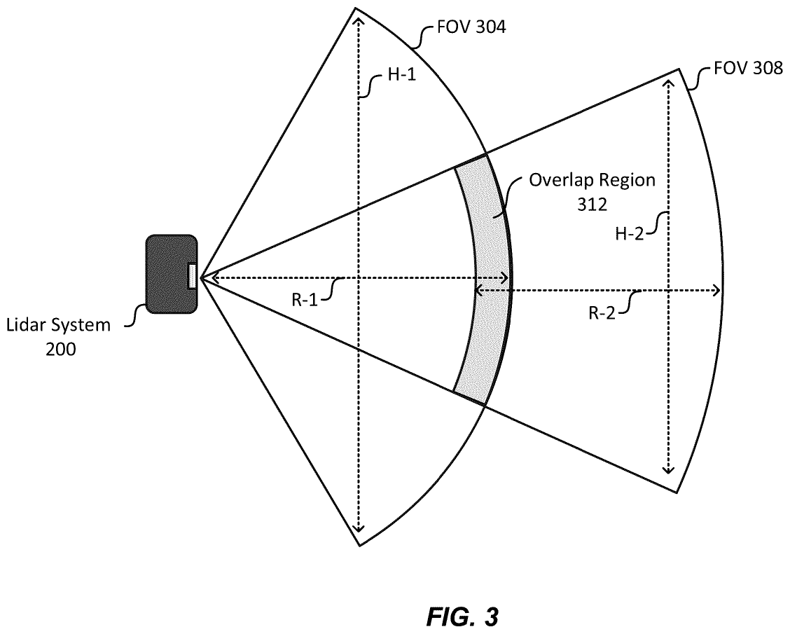

FIG. 3 is an example graphical representation of the two fields of view for lidar system 200 of FIG. 2. FIG. 3 illustrates a first field of view (FOV) 304 and a second FOV 308. The first FOV 304 (e.g., using 905 nm light) is for wider and shorter sensing, and the second FOV 308 (e.g., using 940 nm light) is for narrower and longer-range sensing.

As illustrated in FIG. 3, this architecture results in two distinct but complementary sensing zones. As examples, the first FOV 304 has a horizontal FOV, H-1=120 degrees, and a vertical FOV (into and out of the page) equal to 25°, with an effective range R-1 from 0.1 to 300 meters; the second FOV 308 has a narrower horizontal FOV, H-2=60°, and a vertical FOV of 12°, with an effective range R-2 from 200 to 500 meters. The system can be designed with an overlap region 312 (e.g., between 200 m and 300 m) where both subsystems can detect objects, allowing for sensor fusion and robust performance.

### B. Time-Delayed Ranging for Enhanced Long-Range Accuracy

Time-delayed ranging can be used to improve the accuracy of long-range measurements. In ToF systems, measuring long distances with high precision can often use complex and/or high-frequency counters. To simplify this, a time delay in the measurement process for the long-range detectors can be used. The measurement counter is initiated only after a delay corresponding to the travel time of light to a minimum desired range (e.g., a range equal to (or greater than) 200, 225, 250, 255, 260, 270, or 300 meters). This allows the system to use a high-resolution counter over a specific, limited long-range window (e.g., 250 m to 500 m), improving accuracy without using an excessively complex design.

In some configurations, the measurement process for the long-range FOV (e.g., the second FOV 308 in FIG. 3) is enhanced. For example, the second detector 232 (and the second detector array) in FIG. 2, the ToF counter is not started immediately upon the emission of a laser pulse from the second laser 208. Instead, the processing unit introduces a fixed time delay before initiating the count detecting light at the second detector 232. This delay corresponds to the round-trip time of light to a minimum threshold distance, for instance, 200 or 250 meters. By starting the measurement only after this delay, the system effectively ignores reflections from objects closer than 200 or 250 meters on this channel and can dedicate the full dynamic range of its counter to the desired long-range window (e.g., 250 m to 500 m). This allows for higher temporal resolution and thus more precise distance measurements within that specific range without using an overly complex or expensive high-speed counter.

### C. Dual-Array Architecture for Velocity Measurement

Conventional lidar systems do not directly measure the velocity of an object. Velocity can be inferred by comparing the position of an object across multiple consecutive frames of data. Often, one frame is one rotation, oscillation, or raster scan of a scanning mirror. The time delay between frames can be significant in time-sensitive situations, such as for autonomous vehicle collision avoidance, where nearly instantaneous velocity information is highly desirable. While other technologies like Frequency Modulated Continuous Wave (FMCW) lidar can measure velocity directly via the Doppler effect, they often come with their own set of complexities and costs.

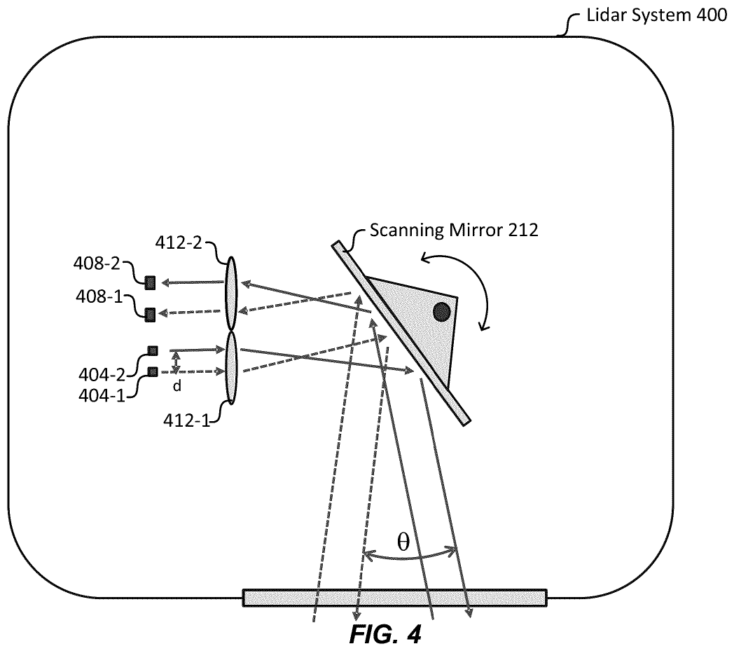

FIG. 4 is a schematic diagram of an embodiment of a lidar system 400 configured for rapid velocity measurement, utilizing two angularly separated laser arrays. A probe laser is set a few degrees from a main laser for single frame velocity detection. Rapid velocity measurement in this context refers to faster than one frame but not instantaneous as in FMCW lidar velocity measurement.

Lidar system 400 comprises a first laser 404-1 and a second laser 404-2. The first laser 404-1 can be part of a first laser array (e.g., a column of lasers extending into and out of the sheet). The second laser 404-2 can be part of a second laser array (e.g., a column of lasers extending into and out of the sheet). In some configurations, the first laser 404-1 in FIG. 4 is the same laser as the first laser 204 in FIG. 2, and the second laser 404-2 in FIG. 4 is part of the first laser array described in FIG. 2 and in a different column than the first laser 204 (e.g., a laser top or bottom of laser 204 and/or one or more columns of lasers top or bottom of laser 204). A similar configuration could be used for the second laser 208 in FIG. 2 (e.g., a second laser to the left or right of laser 208 or having multiple columns of lasers left or right of laser 208). The first laser 404-1 is separated by a distance d from the second laser 404-2. A first detector 408-1 and second detector 408-2 are used to detect reflected light from an object in the field of view. The detectors 408 can be part of one-dimensional or two-dimensional detector arrays. Detectors 408 can calculate distances from the lidar system 400 to one or more objects in the field of view. By knowing orientation information and distance information, the lidar system 400 can calculate a position of an object in the environment (e.g., in relation to the lidar system 400).

Lidar system 400 uses two lasers (or two vertical lines of illumination) that are physically separated by the distance d, corresponding to a slight angular separation theta θ (e.g., between 1 and 15 degrees, 1 and 10 degrees, or 2 and 6 degrees; such as 4 degrees plus or minus 1, 2, or 3 degrees) in the FOV.

As the scanning mirror 212 sweeps the laser beams across the scene, it effectively captures two images of the same object separated by a very short, known time interval. A processing unit can then calculate the object's velocity in one or more dimensions by analyzing the change in distance and/or position of the object between these two closely spaced measurements. This “intra-frame” velocity calculation is significantly faster than traditional “inter-frame” methods, providing time-sensitive data for real-time applications. Though two sub images can be calculated, the sub images need not be two dimensional (which a three dimensional image/point cloud with distance information using ToF information). In some configurations, one-dimensional images (meaning scanning in one dimension) are used. In some configurations, just two points are used. For example, a first point from a reflection from the first laser is of an object at a position 80 meters directly in front of the lidar system 400, and a reflection from the second laser is of an object at a position 60 meters direction in front of the lidar system 400. The two points can be used to detect a velocity (of the object and/or the lidar system 400) in a direction directly in front of the lidar system 400 (e.g., and hence a vehicle; for anti-collision). In some situations, one-dimensional and/or two-dimensional sub images can provide additional information about the movement of an object. For example, an object moving parallel, perpendicular, or skew (not just head-on) to the lidar system 400 can be tracked and the position and velocity of the object calculated.

A first lens 412-1 is used to shape a beam from the first laser 404-1, the second laser 404-2, or both (in some embodiments, the second laser 404-2 has its own lens). Lasers 404 may be part of two vertical arrays of lasers, or two individual lasers whose beams are shaped into vertical lines by non-cylindrical optics. In some configurations, each column of lasers share one lens. In some configurations, multiple columns of lasers share a lens.

A second lens 412-2 is used to focus reflected light from the object onto the first detector 408-1, the second detector 408-2, or both (in some embodiments, the second detector 408-2 has its own lens). Lens 412 can be a simple lens or comprise an optical train. In some configurations, each column of detectors share one lens. In some configurations, multiple columns of detectors share one lens.

As the scanning mirror 212 sweeps light from the lasers 404 (or lines from two columns of lasers) across the FOV, they create two distinct data points (or two images when combined with data from other light sources to form a point cloud image) from detectors 408. Because of the angular separation θ, the second laser 404-2 illuminates a given point in the scene a short time t after the first laser 404-1. This time delay t is a function of the angular separation θ and the angular velocity ω of the scanning mirror, given by a function such as t=θ/(2ω), or t=θ/ω (e.g., for a rotating mirror).

The processing unit analyzes a radial distance r measured for corresponding pixels in the two images. The change in radial distance, Δr, over the known time t allows for a direct calculation of the object's radial velocity (Vr=Δr/t). By using perception software to identify objects in the point cloud, the system can analyze the change in an object's position in three dimensions (e.g., r, theta, and phi; or x, y, and z) between the two sub-frame images to calculate its full 3D velocity vector. Because the time t is much shorter than the time used to capture two full frames, this method provides velocity information far more rapidly than conventional ToF lidar.

In some embodiments, to optimize processing power, the velocity analysis is performed pixel-by-pixel rather than at the object level (e.g., in lieu of the object-level analysis, before the object level analysis, or as part of the object-level analysis). Due to limited processing power within the lidar unit, object identification can be computationally expensive. Instead, the processing unit directly measures a radial distance change between a first pixel illuminated by the first laser and a corresponding second pixel illuminated by the second laser. Dividing this radial distance change by the time delay between the two illuminations yields a pixel-level radial velocity. After the pixel-level radial velocities are calculated, subsequent post-processing can group pixels sharing substantially the same radial velocity into an identified “object.” Once pixels are grouped into an object, the system can track the object's center and/or edges to calculate a sideways (lateral or transverse) velocity.

In accordance with certain embodiments, the lidar system is configured to cluster a plurality of pixels based on a similarity in their respective radial velocities. The similarity criterion can be established as a function of the noise floor of the velocity estimation process. Specifically, a threshold for grouping is defined such that spatially adjacent pixels exhibiting a radial velocity differential below the system's minimum detectable velocity are associated with a common object. For example, if the smallest velocity that can be reliably detected is 2 km/hr (because of noise in the distance estimate), then adjacent pixels with a radial velocity that differed by less than 2 km/hr are grouped into an object.

Calculating velocity at the pixel level can sometimes introduce edge artifacts. For example, an edge artifact can occur when an object is moving sideways such that a physical edge of the object is detected by the first pixel (from the first laser) but is missed by the corresponding second pixel (from the second laser), which instead detects a background surface. This discrepancy results in an erroneously large radial distance change and an artificially high calculated radial velocity. To remove these edge artifacts, the processing unit is configured to compare the calculated pixel-level radial velocity to a reasonable limit or threshold. If the calculated radial velocity exceeds this limit, the data associated with that pixel pair is ascertained to be an edge artifact and is discarded from the velocity analysis.

In accordance with one or more embodiments, the lidar system implements a spatial filtering module to mitigate noise pixels based on radial velocity disparities. The system is configured to identify a target pixel, or a contiguous column of pixels, exhibiting a radial velocity that deviates from the radial velocities of its immediate spatial neighbors (e.g., those to the lateral left and right) by an amount exceeding a predetermined threshold. This outlier detection may similarly be applied along a vertical axis to identify pixels deviating from neighbors located above and below the target pixel.

In some configurations, pixels from the second frame (generated by the second laser or laser array) are interleaved or interspersed between the pixels of the first frame (generated by the first laser or laser array). To achieve this, the second laser is physically offset from the first laser by a fractional pixel distance, such as a ½ pixel offset vertically, horizontally, or both. Interleaving the pixels effectively doubles the total number of points in the resulting point cloud, improving the overall spatial resolution by a factor of approximately \sqrt{2}. While interleaving pixels may slightly increase noise and the occurrence of edge artifacts (since corresponding pixels from the first and second lasers do not exactly match the same physical coordinate), the artifact removal algorithm described above can effectively discard these anomalies. Consequently, the trade-off yields a significantly higher-resolution point cloud with clean, highly accurate velocity measurements.

In embodiments employing interleaved pixel sampling, the evaluation window may be expanded to include a wider spatial neighborhood, such as adjacent pixels and those at a second-degree offset (e.g., i±1 and i±2). The filtering algorithm may calculate a reference velocity using a weighted average of neighboring pixels to ascertain if the target pixel constitutes noise. Furthermore, for objects moving at high transverse velocities relative to the pulse repetition frequency, the system may be configured to identify and suppress clusters of noise pixels spanning multiple contiguous columns.

In some configurations, detectors are offset instead of, or in addition to offsetting lasers. In some configurations, lasers and/or detectors are offset vertically and horizontal shift is offset by timing (e.g., sweeping with a mirror).

The data and/or images from detectors 408 is taken from the same sweep (e.g., oscillation or rotation) of the scanning mirror 212. Put another way, light from both the first laser 404-1 and the second laser 404-2 are incident on the same mirror while the mirror is rotating in one direction and before the mirror changes direction; and light is detected by the first detector 408-1 and the second detector 408-2 while the mirror is rotating in the one (the same) direction (e.g., from reflections and before the mirror changes direction).

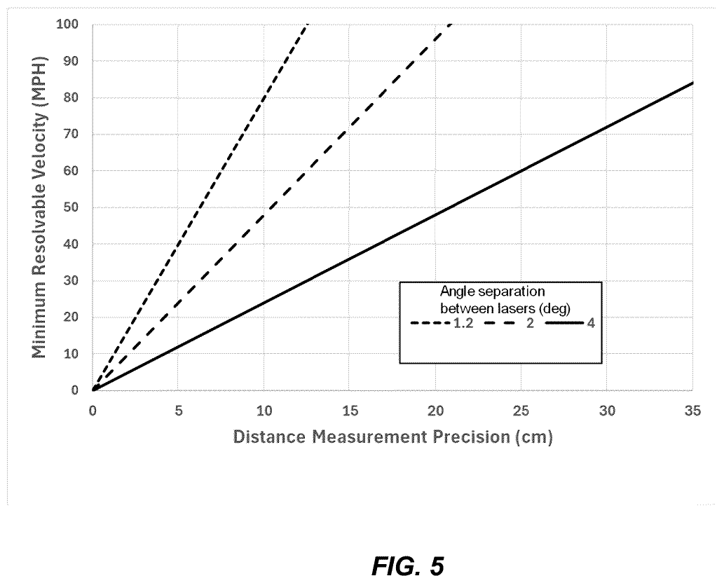

FIG. 5 is a graph illustrating the relationship between the angular separation of laser arrays, distance measurement precision, and the minimum resolvable velocity, for example the lidar system shown in FIG. 4.

FIG. 5 illustrates some design trade-offs for this system. A larger separation angle θ results in a longer time delay t, which allows for more accurate measurement of slow-moving objects. However, a larger angle may use more complex optics and a larger scanning range to ensure the two images fully overlap. The precision of the velocity measurement can depend on the precision of the underlying distance measurements.

Theta has been chosen between 1 and 15 degrees, and in some configurations near 4 degrees, because if an object is moving slowly, velocity might not be calculated properly for low theta (e.g., less than one degree). Conversely, for an object, such as a car going really fast, a large theta might miss the object. Also, a large theta can also reduce an effective field of view. For example, if theta is 15 degrees and the field of view is 90 degrees, the effective field of view would be 75 degrees. An angular separation (theta) of around 4 degrees can provide a balance between these competing factors.

In some configurations, more than two lasers 404 (or more than two columns or two arrays of lasers) are used. For example, three arrays of lasers are used to get three velocity measurements. In this example, there could be a 4-degree theta between a first laser array and a second laser array lines, a 4-degree theta between the second laser array and a third laser array lines, and an 8-degree theta between the first laser array and the third laser array lines. Velocity measurements could be made from the differences between the first and second laser array lines, the second and third laser array lines, and the first and third laser array lines (to detect slower movement). In some configurations, velocity measurements could be disregarded at the fringes (e.g., in one direction, velocity measurements using the first laser array could be discarded, and in the other direction, velocity measurements using the third laser array could be discarded). In that way, an effective field of view could still be the gross FOV minus theta (e.g., instead of gross minus two theta). This would discard slower velocity detection at the fringes of the field of view, and that can be acceptable in some situations.

While FIG. 4 shows a reciprocal scanning mirror, it could also be replaced by a rotating polygonal mirror. Also, the mirror could be scanning in the vertical direction, in which case the laser arrays would be arranged to produce horizontal lines of illumination.

In some cases, the two laser arrays and detection system may have symmetrical functionality, so that when a reciprocating mirror reverses direction, the laser array and detector array producing the first image then produces the second image. In some cases, the two arrays may be optimized for slightly different functionality. For example, the first laser and detector array may be optimized for low power, while the second laser and detector array may be optimized for high accuracy.

The two laser arrays can also be used for additional functionality, such as using the first laser array to measure the reflectivity of an object, so that the power of the 2nd laser array can be adjusted to avoid saturation of the detector for bright objects such as retro-reflective signs.

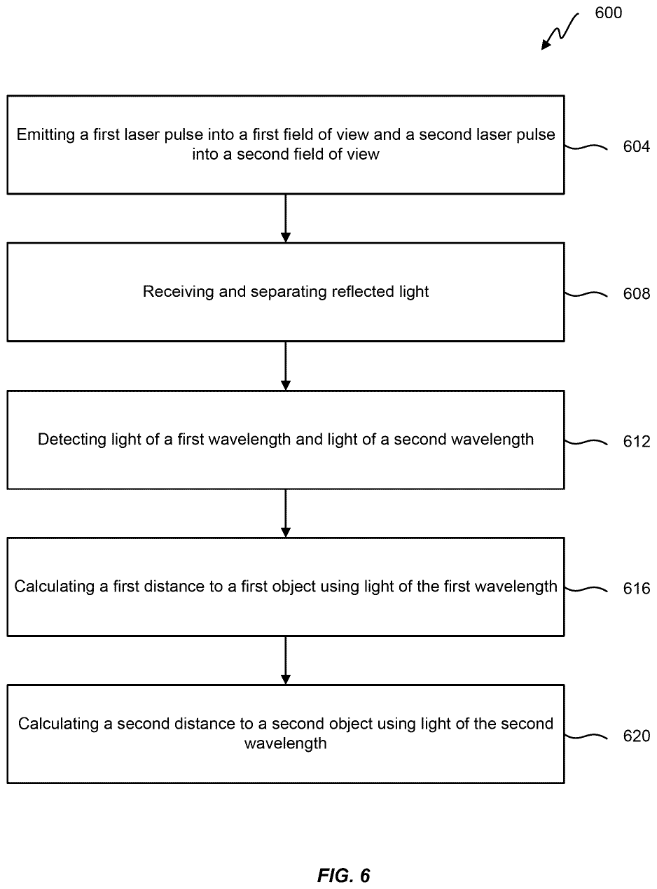

Referring next to FIG. 6, a flowchart of an embodiment of a process 600 for lidar to detect near and far objects. Process 600 begins in step 604 with emitting a first laser pulse within a first field of view and emitting a second laser pulse within a second field of view (e.g., as described in FIGS. 2 and 3). The first laser pulse is characterized by a first wavelength and the second laser pulse is characterized by a second wavelength. In some configurations, emitting the second laser pulse is performed concurrently with emitting the first laser pulse. In some configurations, emitting the second laser pulse is performed with 0.00001, 0.001, 0.01, 0.1, or 0.25 seconds of emitting the first laser pulse.

In step 608, reflected light from the first field of view and from the second field of view is received (e.g., by the scanning mirror in FIG. 2) and separated (e.g., by beam splitter 220 in FIG. 2). Received light is separated into a first optical path corresponding to the first wavelength and a second optical path corresponding to the second wavelength.

In step 612, light of a first wavelength and light of a second wavelength is detected. A first detector (e.g., detector 228 in FIG. 2) positioned in the first optical path detects reflected light of the first wavelength. A second detector (e.g., detector 232 in FIG. 2) positioned in the second optical path detects reflected light of the second wavelength.

In step 616 a first distance to a first object in the first field of view is calculated based on the first detector detecting reflected light corresponding to the first wavelength. In step 612, a second distance to a second object in the second field of view is calculated based on the second detector detecting reflected light corresponding to the second wavelength. In some configurations, the second distance is more than 150, 200, 250, 300, 350, or 400 meters greater than the first distance.

In some configurations, the method further comprises 28 passing light of the first wavelength though a first lens with a first focal length, wherein the first lens is in the first optical path; and/or passing light of the second wavelength through a second lens with a second focal length, wherein the second lens in in the second optical path.

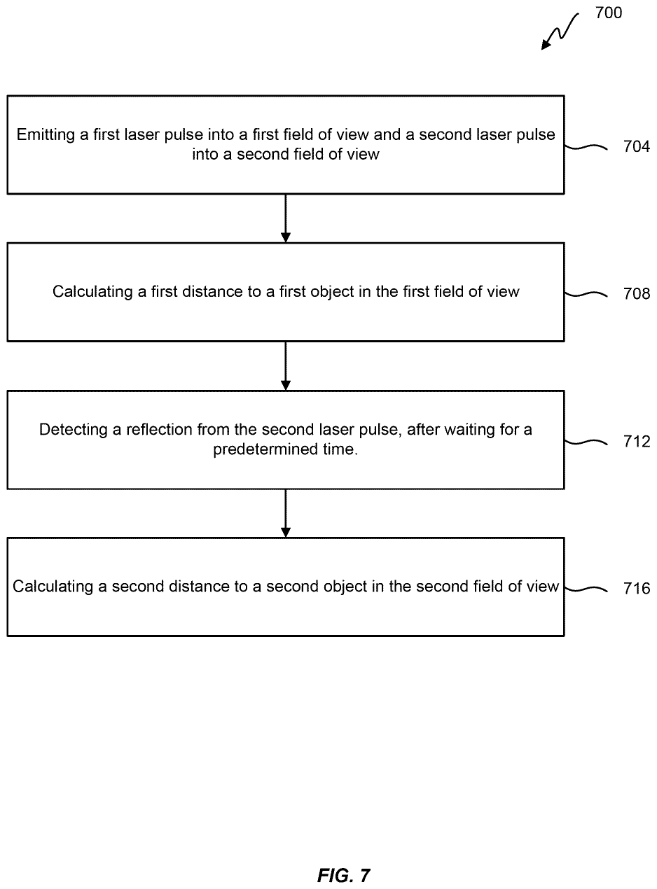

Referring next to FIG. 7, a flowchart of an embodiment of a process 700 for measuring a distance using a lidar system. Process 700 begins in step 704 with emitting a first laser pulse into a first field of view and a second laser pulse into a second field of view (e.g., similar to step 604 in FIG. 6).

In step 708, a first time-of-flight measurement is used to calculate a first distance to a first object in the first field of view, in response to detecting, using a first detector (e.g., detector 228 in FIG. 2) a reflection of the laser pulse from a first object within the first field of view.

In step 712, the system waits for a predetermined time delay after the emission of the second laser pulse before detecting a reflection from the second laser pulse using a second detector (e.g., detector 232 in FIG. 2). A second time-of-flight measurement is calculated based on the reflection from the second laser pulse being detected by the second detector.

In step 716, a second distance to a second object in the second field of view is calculated based on the second time-of-flight measurement. The second range is more distant from the LIDAR system than the first range.

In some configurations, the predetermined time delay corresponds to the round-trip travel time of light to a minimum distance of the second field of view; the minimum distance of the second range is equal to or greater than 250 meters; and/or the first field of view and the second field of view are at least partially overlapping.

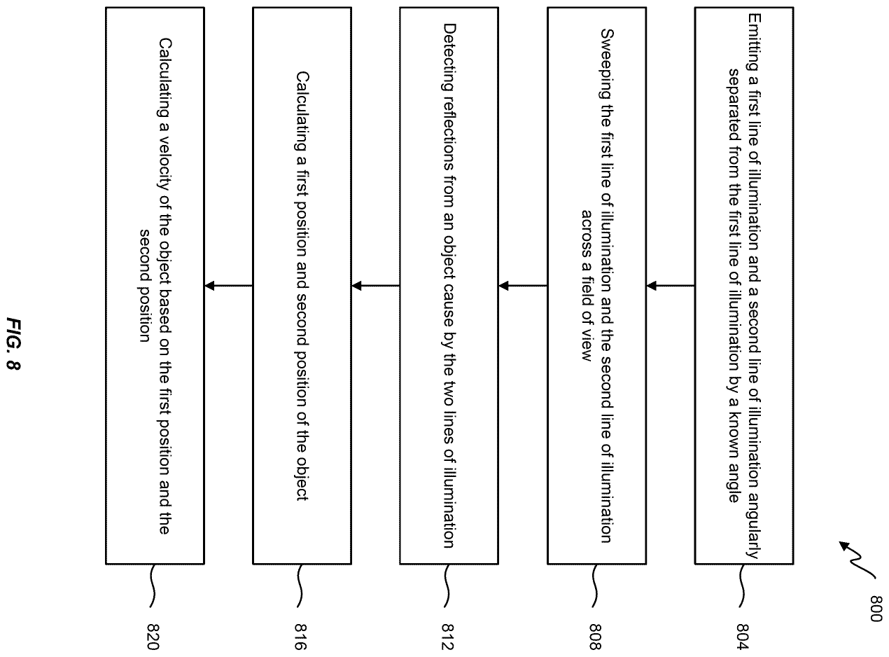

Referring next to FIG. 8, a flowchart of an embodiment of a process 800 for detecting velocity of an object using lidar. Process 800 begins in step 804 with emitting light from a first laser and emitting light from a second laser. Emitting light from the first laser is configured to produce a first line of illumination. Emitting light from the second laser is configured to produce a second line of illumination. The second line of illumination is angularly separated from the first line of illumination by a known angle. In some configurations, a line of illumination is formed by a laser emitting pulses of light (e.g., rapidly).

In step 808, a scanning mirror is used to sweep the first line of illumination and the second line of illumination across a field of view. An object in the field of view is illuminated by the second line of illumination at a known time delay after being illuminated by the first line of illumination.

In step 812, reflections from an object in the field of view caused by the first and second lines of illumination are detected by two or more detectors. For example, a first sub-image (e.g., a first 3D image as a first point cloud) is created by sweeping the first line of illumination across the field of view and detecting reflections from the object, and a second sub-image (e.g., a second 3D image as a second point cloud) is created by sweeping the second line of illumination across the field of view and detecting reflections.

In step 816, a first distance to the object and/or position of the object is calculated from detecting reflections from the first line of illumination and a second distance to the object and/or position of the object is calculated from detecting reflections from the second line of illumination.

In step 820, a velocity of the object is calculated based on a difference between the first distance, the second distance, and the known time delay or between the first position, the second position, and the known time delay (e.g., as discussed in relation to FIGS. 4 and 5).

In some configurations, the method further comprises calculating a three-dimensional velocity vector of the object by analyzing a change in position of the object between a first sub image generated from data with the first reflection and a second sub image generated from data with the second reflection.

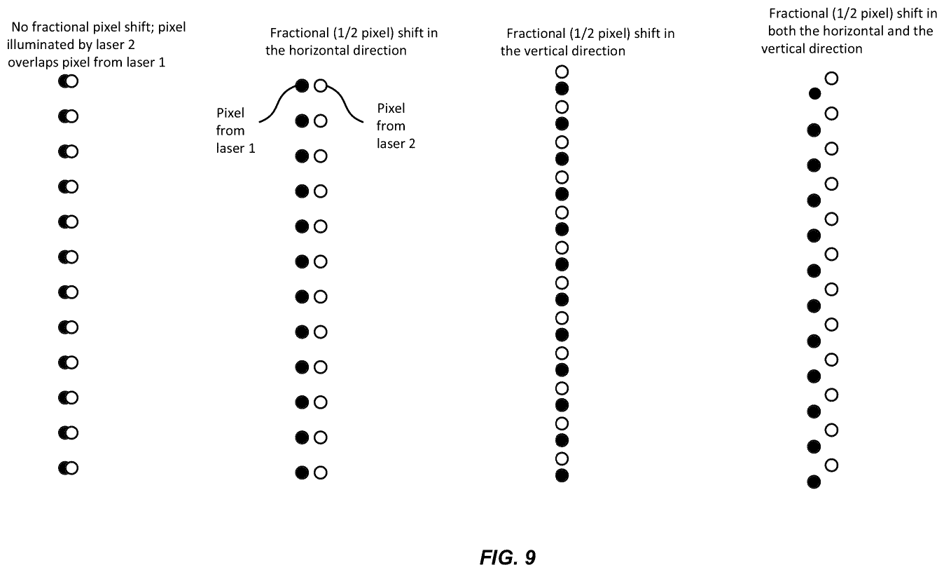

Referring to FIG. 9, various configurations for implementing a fractional pixel shift between a first illumination (e.g., from a first laser or laser array) and a second illumination (e.g., from a second laser or laser array) are illustrated. In the illustrated examples, pixels from a first laser are represented by solid circles, while pixels from a second laser are represented by open circles. As previously described, a fractional pixel offset allows for the interleaving of data points to effectively increase the spatial resolution of the resulting point cloud.

As shown in the leftmost example of FIG. 9, the system may be configured with no fractional pixel shift, wherein pixels illuminated by the second laser substantially overlap pixels illuminated by the first laser. In some embodiments, a fractional shift (e.g., a ½ pixel shift) may be implemented in one or more dimensions.

A horizontal fractional shift may be achieved by adjusting the timing of the laser firing pulses relative to the scanning mirror's angular velocity.

A vertical fractional shift may be achieved by a physical spatial offset of the hardware components. In some configurations, the second laser is physically offset from the first laser by a fractional distance. In some configurations, the detectors are physically offset, or a combination of laser and detector offsets is utilized. As illustrated in the third and fourth examples of FIG. 9, vertical shifting allows for the interleaving of pixels between existing rows, thereby doubling the vertical sampling density.

The system may further implement a fractional shift in both the horizontal and vertical directions simultaneously, as shown in the rightmost example. While offsets may increase the likelihood of edge artifacts due to the non-identical physical coordinates of corresponding pixels, the previously described artifact removal and spatial filtering algorithms ensure high-resolution, accurate velocity measurements.

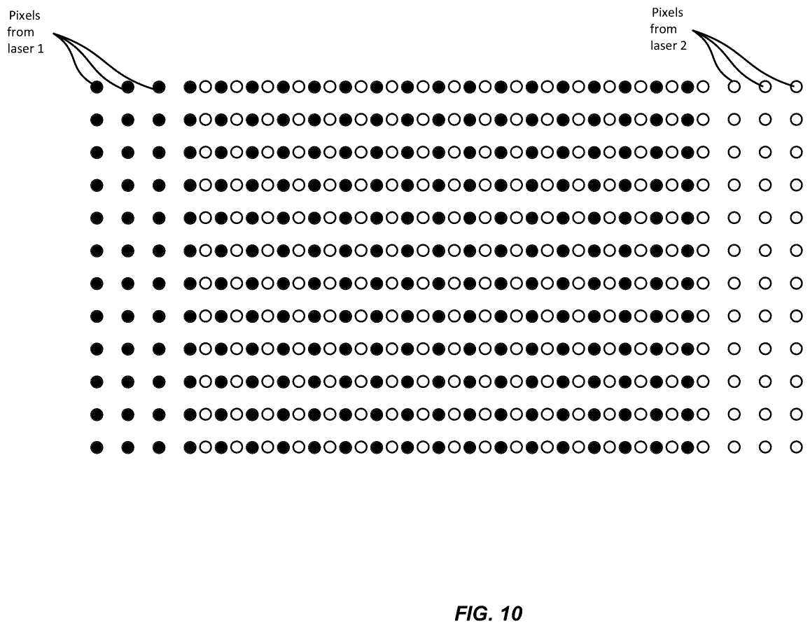

Referring to FIG. 10, an example of a series of pulses from a first laser array and a second laser array is shown as they are scanned across a field of view (FOV). In this embodiment, pixels generated from reflections of the first laser are represented by solid circles, while pixels generated from reflections of the second laser are represented by open circles. As the scanning mirror sweeps across the FOV, it projects lines of illumination from both laser arrays, resulting in the illustrated grid of data points.

Light from the second laser is horizontally shifted by a fractional pixel distance relative to the first laser. In this example, the horizontal shift is a ½ pixel offset. This horizontal displacement may be achieved by adjusting the timing of the firing pulse of the second laser array relative to the first laser array as the scanning mirror moves. By controlling the firing interval, the pixels from the second laser are interspersed (or interleaved) between the pixels of the first laser along the horizontal axis.

Interspersing pixels in this manner effectively doubles the number of data points collected in a single sweep, thereby enhancing the spatial resolution of the resulting point cloud. Furthermore, because the second laser array illuminates a specific region of the scene at a known time delay after the first laser array, the processing unit can utilize these horizontally-offset pixel pairs to calculate pixel-level radial velocity and perform noise mitigation and object grouping operations described herein.

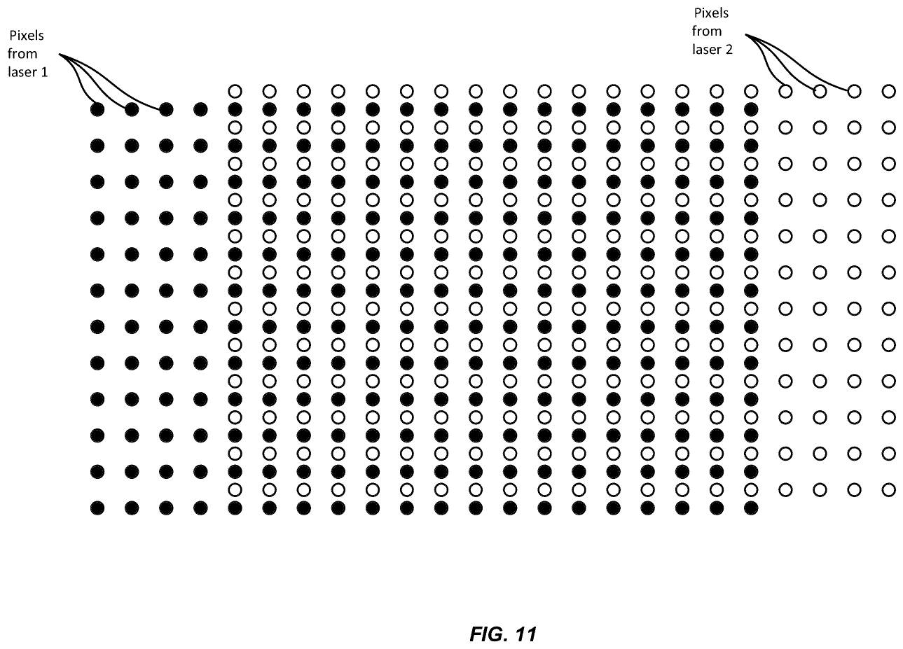

Referring to FIG. 11, another embodiment of a series of pulses from a first laser array and a second laser array is illustrated as they are scanned across the field of view (FOV). In this graphical representation, pixels resulting from reflections of the first laser array are depicted as solid circles, while pixels resulting from reflections of the second laser array are depicted as open circles.

As shown in the illustrated series of pulses, the second laser is vertically shifted by a fractional pixel distance relative to the first laser. The vertical shift in this embodiment is approximately a ½ pixel offset. This vertical shift can be achieved through a physical spatial offset of the hardware components, such as a physical displacement of the first laser relative to the second laser, or a physical displacement between corresponding elements in a detector array. In some configurations, scanning is also performed in the vertical direction.

This vertical interleaving allows the pixels of the second illumination to be interspersed between the rows of pixels generated by the first illumination. By positioning the second set of data points in the vertical gaps between the first set, the system effectively doubles the vertical sampling density can improve the overall spatial resolution of the constructed point cloud. Furthermore, as each vertically-offset pixel from the second laser is captured at a known time delay after a corresponding pixel from the first laser, the processing unit can utilize the resulting data to calculate pixel-level radial velocity and perform the spatial filtering and object clustering operations described herein.

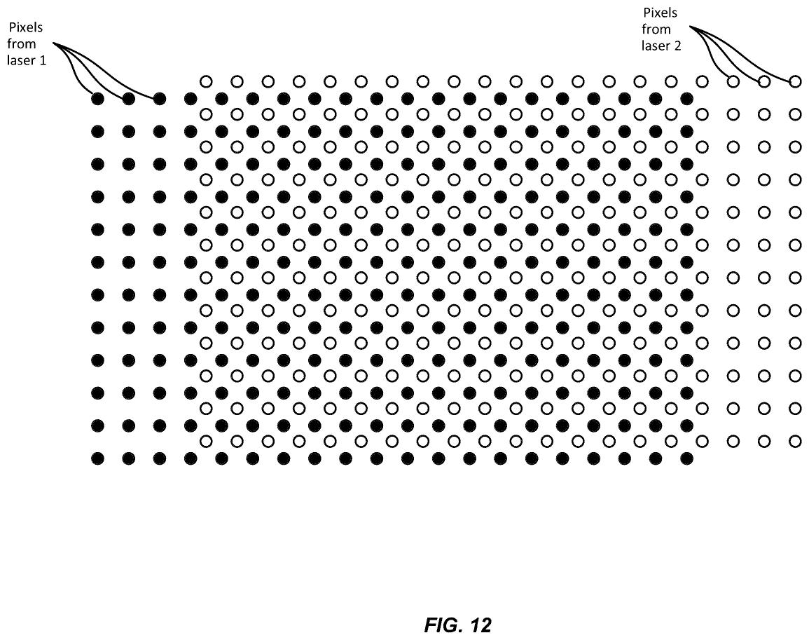

Referring to FIG. 12, an embodiment is shown illustrating a series of pulses from a first laser array and a second laser array as they are scanned across a field of view (FOV). In this representation, pixels generated from reflections of the first laser array are depicted as solid circles, while pixels generated from reflections of the second laser array are depicted as open circles. As a scanning mirror sweeps the lines of illumination across the scene, the processing unit generates a combined point cloud from the two sets of laser data.

In this configuration, the pixels of the second laser array are shifted both horizontally and vertically by a fractional pixel distance relative to the pixels of the first laser array. In the illustrated example, a ½ pixel offset is implemented in both the horizontal and vertical dimensions. This dual-axis shift may be achieved through a combination of physical hardware arrangements and operational timing. For example, the vertical offset may be established by physically shifting the lasers, the detectors, or a combination thereof. The horizontal offset is established by adjusting the timing of the laser firing pulses (e.g., a timing shift) in synchronization with the angular velocity of the moving scanning mirror.

This combined horizontal and vertical interleaving serves to populate the spatial gaps between pixels in both dimensions, effectively doubling the sampling density and enhancing the spatial resolution of the three-dimensional point cloud. Because each pixel from the second laser array is captured at a known time delay after a corresponding pixel from the first laser array, this dense data set also allows the processing unit to perform pixel-level radial velocity calculations.

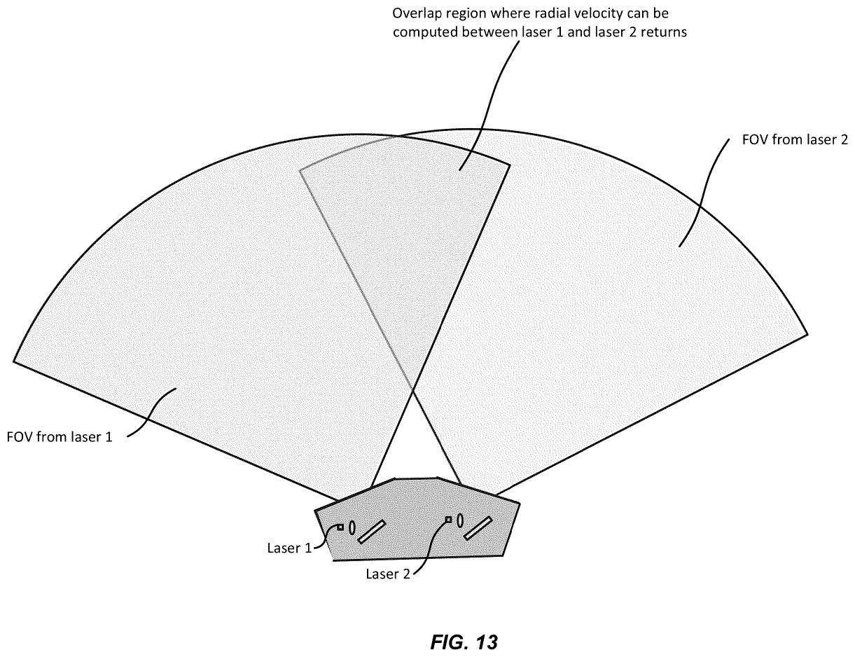

Referring to FIG. 13, an optical arrangement and an overlap field of view (FOV) are illustrated for a lidar system comprising a first laser (Laser 1) and a second laser (Laser 2). In this embodiment, the first laser and the second laser share a single, common housing but utilize separate optical paths for their respective illuminations.

As shown, the first laser projects a first field of view (FOV from laser 1), and the second laser projects a second field of view (FOV from laser 2). The system is configured such that these fields of view at least partially overlap to form an overlap region. Within this overlap region, the processing unit is configured to compute radial velocity between the returns of the first laser and the returns of the second laser.

To facilitate velocity calculations, the scanning and laser pulse timing between the first laser and the second laser are synchronized and calibrated against each other. This synchronization allows the system to establish the known time delay between measurements of the same object point as it passes through the separate optical paths. By maintaining this calibrated relationship within a single housing, the system can reliably perform the pixel-level radial velocity estimations and object tracking described herein.

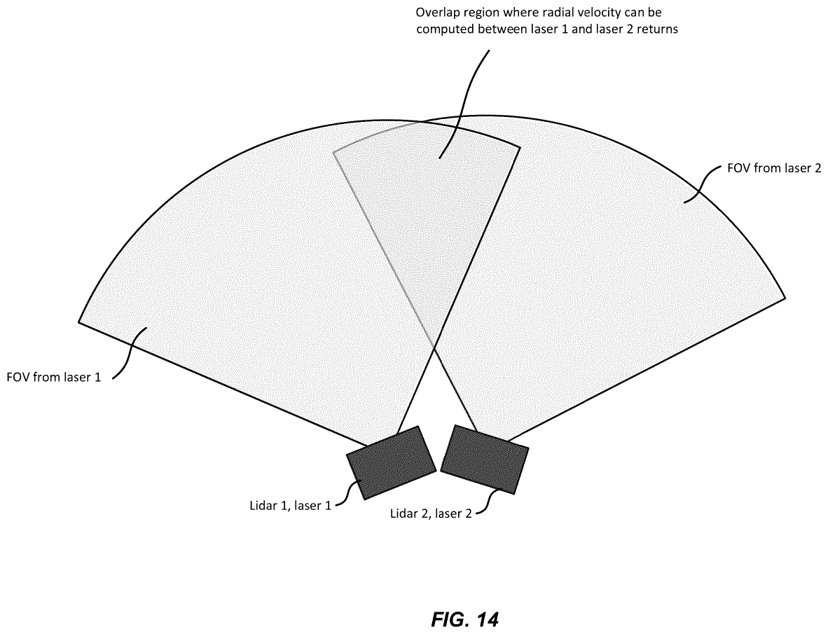

Referring to FIG. 14, an optical arrangement and an overlap field of view (FOV) are illustrated for a system where a first laser (Laser 1) and a second laser (Laser 2) are disposed within physically separate lidar units. In this configuration, the first laser projects a first field of view (FOV from laser 1), and the second laser projects a second field of view (FOV from laser 2).

As illustrated, the two independent lidar units are oriented such that their respective fields of view at least partially overlap to form an overlap region. Similar to the single-housing embodiment described in FIG. 13, the processing unit (or multiple synchronized processing units) is configured to compute radial velocity between the returns of the first laser and the returns of the second laser within this overlap region.

To enable accurate velocity computation across physically separate units, the first and second lidar units are calibrated and synchronized with each other. This synchronization ensures that the scanning and laser pulse timing of both units are aligned, allowing the system to determine a time delay between measurements of the same pixel location or object as it is detected by the first unit and subsequently by the second unit (or vice versa). By maintaining synchronization between independent units, the system can provide extended coverage and multi-perspective velocity measurements within the combined sensing environment.

In some configurations, synchronization between laser 1 and laser 2 (e.g., as shown in FIGS. 3, 4, 13, and 14) is such that laser 2 fires a spatially corresponding pixel to laser 1, offset by a fraction of a frame time, such as from 1/50 of a frame time to ½ of a frame time. For example, if the system is taking data at 10 frames/second, the 2nd laser might be fired from 1/500 to 1/20 of a second after the first laser. A minimum time can be set by the desired minimum velocity measurement, which in turn can depend on the noise in the distance measurement data. If the maximum exceeds ½ of a frame time, then it may be preferred, in some configurations, to simply use frame-to-frame measurements from a single laser or laser array.

Various features described herein, e.g., methods, apparatus, computer-readable media and the like, can be realized using a combination of dedicated components, programmable processors, and/or other programmable devices. Some processes described herein can be implemented on the same processor or different processors. Where some components are described as being configured to perform certain operations, such configuration can be accomplished, e.g., by designing electronic circuits to perform the operation, by programming programmable electronic circuits (such as microprocessors) to perform the operation, or a combination thereof. Further, while the embodiments described above may make reference to specific hardware and software components, those skilled in the art will appreciate that different combinations of hardware and/or software components may also be used and that particular operations described as being implemented in hardware might be implemented in software or vice versa.

Details are given in the above description to provide an understanding of the embodiments. However, it is understood that the embodiments may be practiced without some of the specific details. In some instances, well-known circuits, processes, algorithms, structures, and techniques are not shown in the figures.

While the principles of the disclosure have been described above in connection with specific apparatus and methods, it is to be understood that this description is made only by way of example and not as limitation on the scope of the disclosure. Embodiments were chosen and described in order to explain principles and practical applications to enable others skilled in the art to utilize the disclosure in various embodiments and with various modifications, as are suited to a particular use contemplated. It will be appreciated that the description is intended to cover modifications and equivalents.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary. Patents, patent applications, publications, and descriptions mentioned here are incorporated by reference in their entirety for all purposes. None is admitted to be prior art.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of embodiments of the disclosure has been presented for the purposes of illustration and description. It is not intended to be exhaustive or to limit the disclosure to the precise form described, and many modifications and variations are possible in light of the teaching above. The embodiments were chosen and described in order to explain the principles of the invention and its practical applications to thereby enable others skilled in the art to utilize the invention in various embodiments and with various modifications as are suited to the particular use contemplated.

What is claimed is:

1. A system for lidar comprising:
a first laser configured to project a first illumination in a field of view;
a second laser configured to project a second illumination angularly separated from the first illumination in the field of view;
a scanning mirror configured to sweep the first illumination and the second illumination across the field of view;
at least one detector configured to detect reflections of the first illumination and the second illumination from an object in the field of view; and
a processing unit configured to:
calculate a first radial distance for a first pixel based on a detected reflection of the first illumination;
calculate a second radial distance for a second pixel based on a detected reflection of the second illumination, wherein the second pixel corresponds to the first pixel after a known time delay; and
calculate a pixel-level radial velocity based on a difference between the first radial distance and the second radial distance divided by the known time delay.

2. The system of claim, wherein the processing unit is further configured to:
ascertain whether the pixel-level radial velocity exceeds a predetermined limit indicative of an edge artifact; and
discard data associated with the first pixel and the second pixel in response to ascertaining the pixel-level radial velocity exceeds the predetermined limit.

3. The system of claim, wherein the processing unit is further configured to group remaining pixels sharing a similar pixel-level radial velocity into a recognized object.

4. The system of claim, wherein the processing unit is further configured to calculate a transverse velocity of the recognized object by tracking a center or an edge of the recognized object.

5. The system of claim, wherein the second laser is physically offset by a fractional pixel distance relative to the first laser.

6. The system of claim, wherein the fractional pixel distance is offset in a vertical direction.

7. A method for measuring velocity using a lidar system, the method comprising:
projecting, via a first laser, a first illumination in a field of view;
projecting, via a second laser, a second illumination in the field of view, wherein the second illumination is angularly separated from the first illumination;
sweeping, using a scanning mirror, the first illumination and the second illumination across the field of view;
detecting, with at least one detector, reflections of the first illumination and the second illumination from an object in the field of view;
calculating, via a processing unit, a first radial distance for a first pixel based on a detected reflection of the first illumination;
calculating, via the processing unit, a second radial distance for a second pixel based on a detected reflection of the second illumination, wherein the second pixel corresponds to the first pixel after a known time delay; and
calculating, via the processing unit, a pixel-level radial velocity based on a difference between the first radial distance and the second radial distance divided by the known time delay.

8. The method of claim, further comprising:
ascertaining, via the processing unit, whether the pixel-level radial velocity exceeds a predetermined limit indicative of an edge artifact; and
discarding data associated with the first pixel and the second pixel in response to ascertaining that the pixel-level radial velocity exceeds the predetermined limit.

9. The method of claim, further comprising grouping remaining pixels sharing a similar pixel-level radial velocity into a recognized object representation.

10. The method of claim, wherein the similarity in pixel-level radial velocity is established as a function of a noise floor of a velocity estimation process, such that spatially adjacent pixels exhibiting a radial velocity differential below a minimum detectable velocity are associated with the recognized object.

11. The method of claim, further comprising calculating a transverse velocity of the recognized object by tracking a change in position of a center or an edge of the recognized object.

12. The method of claim, wherein the edge artifact comprises a measurement anomaly caused by a transverse-moving object detected by the first pixel and missed by the corresponding second pixel.

13. The method of claim, further comprising identifying a target pixel exhibiting a radial velocity that deviates from the radial velocities of its immediate lateral or vertical spatial neighbors by an amount exceeding a predetermined spatial disparity threshold.

14. The method of claim, further comprising adjusting a timing of a second laser pulse relative to a first laser pulse such that a location in the field of view is offset by a fraction of a pixel.

15. The method of claim, wherein the second laser is physically offset by a fractional pixel distance relative to the first laser.

16. The method of claim, wherein:
the fractional pixel distance is offset in a vertical direction; and
the method further comprises interleaving pixels generated by the second illumination between pixels generated by the first illumination to generate a point cloud.

17. The method of claim, further comprising calculating a reference velocity using a weighted average of a plurality of neighboring pixels to ascertain if a target pixel constitutes noise.

18. A non-transitory computer-readable medium storing instructions that, when executed by one or more processors of a lidar system, cause the one or more processors to perform operations comprising:
controlling a first laser to project a first illumination in a field of view;
controlling a second laser to project a second illumination in the field of view, wherein the second illumination is angularly separated from the first illumination by a known angle;
controlling a scanning mirror to sweep the first illumination and the second illumination across the field of view;
receiving data from at least one detector indicative of reflections of the first illumination and the second illumination from an object in the field of view;
calculating a first radial distance for a first pixel based on a detected reflection of the first illumination;
calculating a second radial distance for a second pixel based on a detected reflection of the second illumination, wherein the second pixel corresponds to the first pixel after a known time delay; and
calculating a pixel-level radial velocity based on a difference between the first radial distance and the second radial distance.

19. The non-transitory computer-readable medium of claim, wherein a timing of the second illumination is adjusted so a location in the field of view is offset by a fraction of pixel relative to the first illumination.

20. The non-transitory computer-readable medium of claim, the operations further comprising, interleaving pixels generated by the second illumination between pixels generated by the first illumination to generate a point cloud.
